(19) United States
(12) Patent Application Publication
(10) Pub. No.: US 2015/0203272 A1
(43) Pub. Date: Jul. 23, 2015

(54) ABSORBENT PAD HAVING A DESICCANT

(71) Applicant: Paper-Pak Industries, Laverne, CA (US)

(72) Inventor: Sayandro Versteylen, Fontana, CA (US)

(21) Appl. No.: 14/599,098

(22) Filed: Jan. 16, 2015

Related U.S. Application Data
(60) Provisional application No. 61/928,727, filed on Jan. 17, 2014.

(51) Int. Cl. B65D 81/26; B65B 25/00; B32B 3/04; B32B 27/08; B32B 27/32

(52) U.S. Cl. CPC B65D 81/264; B32B 27/08; B32B 27/32; B32B 3/04; B65B 25/001; B32B 2307/74; B32B 2307/744; B32B 2307/758; B32B 2439/70; B32B 2255/20

(57) ABSTRACT

An absorbent pad having a desiccant for absorbing or adsorbing ambient moisture in a food package or in a food display case is provided, to prolong the shelf life and freshness of a food product therein. A method of using the absorbent pad having a desiccant, and optionally another active agent, to prolong the shelf life and enhance the appearance of a food product is also provided, particularly any food product that fosters condensation in the package after packaging, such as baked foods and pre-baked frozen food products.

### CROSS-REFERENCE TO RELATED APPLICATIONS

The present application claims priority of U.S. Provisional Patent Application Ser. No. 61/928,727, filed on Jan. 17, 2014, the contents of which are hereby incorporated by reference in their entirety.

### BACKGROUND OF THE DISCLOSURE

1. Field of the Disclosure

The present disclosure relates to an absorbent pad having a desiccant for absorbing or adsorbing ambient moisture in a food package or in a food display case, to prolong the shelf life and freshness of a food product therein. The absorbent pad can optionally have another active agent. The present disclosure also relates to a method of using the absorbent pad having a desiccant, and optionally another active agent, to prolong the shelf life and enhance the appearance of a food product, particularly any food product that fosters condensation in the package after packaging, such as baked foods and pre-baked frozen food products.

2. Description of the Related Art

Ambient moisture, along with oxygen and heat, can decrease the shelf life and freshness of food products that are in a food package or in a food display case. The moisture and oxygen can promote the growth of microorganisms, molds, and accelerate oxidation that can form compounds that cause off-flavors in the food or cause the food to look and smell stale.

The use of desiccants to reduce ambient moisture in a storage container to protect non-food products is well-known. Silica gel or activated clay are desiccants that are commonly employed in a sachet that, itself, is placed in a storage container to remove ambient moisture in the air (and moisture from the item itself) in boxes for consumer electronic products, such as cameras and cellphones, books, firearms, shoes, and pharmaceuticals. The sachet is often made of a material, such as TYVEK®, that allows water vapor (moisture) to pass through to contact the desiccant, but resists penetration by bulk water (liquid) and air.

However, the use of desiccant sachets in food packages is limited by the risks to consumers. Specifically, sachets of desiccants have only limited applications in packages of wet foods or frozen foods, including baked goods, meat, fruit, and vegetables. Silica gel desiccant, for example, can appear to be salt or granulated sugar, and the sachet can be mistaken by consumers for an edible food product. Further, some desiccants dissolve in water they absorb and, if a sachet of these desiccants is left too long in the food package, the result is an empty, wet sachet, and the potential contact of the contents in the sachet with the food product. Thus, sachets of desiccants have only limited applications in packages of frozen foods, and other types of food that foster condensation in the package.

Baked foods, such as breads, pastries, cookies and cakes, are particularly susceptible to decreases in shelf life and freshness from prolonged contact with ambient moisture. There is a strong consumer demand and restaurant demand for fresh-baked goods. To help meet this demand for fresh-baked goods where the food cannot be baked at the site, pre-baked goods can be prepared so that consumers can take them home to fresh-bake them later. The pre-baked food products are usually made and frozen immediately, and often transported and distributed to the grocery store or restaurant while still frozen. However, during transport, especially over the course of several days, the frozen pre-baked food products can thaw. Sometimes, pre-baked food products are purposely thawed when they reach a retail grocery store so that the consumer buys them partially or completely thawed out. A consumer (or consumer bakery) or restaurant can then fresh-bake them. Some examples of baked foods that are prepared and transported this way include flat breads, pita breads, baguettes, cookies, croissants, and cakes.

For example, flat bread, such as pita bread, often is packaged as a half dozen flat bread units per package from the bread manufacturer. However, when the flat bread package is shipped to a retail grocery or restaurant, if the shipping time to sale or use is six or seven days, the flat bread can become moldy and stale, and the consumer or restaurant may throw out several pieces of the flat bread simply because their appearance is unappealing.

Thus, there is a need for a desiccant that can be placed in a food package or in a food display case that will reduce ambient moisture and increase the shelf life and enhance the appearance of a food product, such as baked goods and pre-baked food products.

### SUMMARY OF THE DISCLOSURE

The present disclosure provides an absorbent pad having a desiccant therein that absorbs or adsorbs ambient moisture in a food package or food display case to increase the shelf life and enhance the appearance of a food product in the package or display.

The present disclosure also provides a food-safe, consumer friendly absorbent pad that contains a desiccant.

The absorbent pad can have a tissue layer that holds and traps excess moisture and water absorbed from the food product, and that can wick away moisture and water from the desiccant, to prevent migration of the desiccant from the pad and potential contamination of the food product in the package.

The present disclosure further provides an absorbent pad that has an atmosphere modification system, such as a carbon dioxide generation system or an oxygen scavenging system, that is activated by the water absorbed or adsorbed by the desiccant to inhibit microbial growth in or reduce oxidation in or on the food product, thereby further prolonging shelf life and enhancing the appearance and freshness of the food product.

### BRIEF DESCRIPTION OF THE DRAWINGS

FIG. 1 is a perspective view of an exemplary embodiment of an absorbent pad having a desiccant of the present disclosure.

FIG. 2 is a cross-section of the absorbent pad of FIG. 1.

FIG. 3 is an exploded view illustrating the layering of another exemplary embodiment of an absorbent pad of the present disclosure.

FIG. 4 is an exploded view illustrating the layering of yet another exemplary embodiment of an absorbent pad

### DETAILED DESCRIPTION OF THE DISCLOSURE

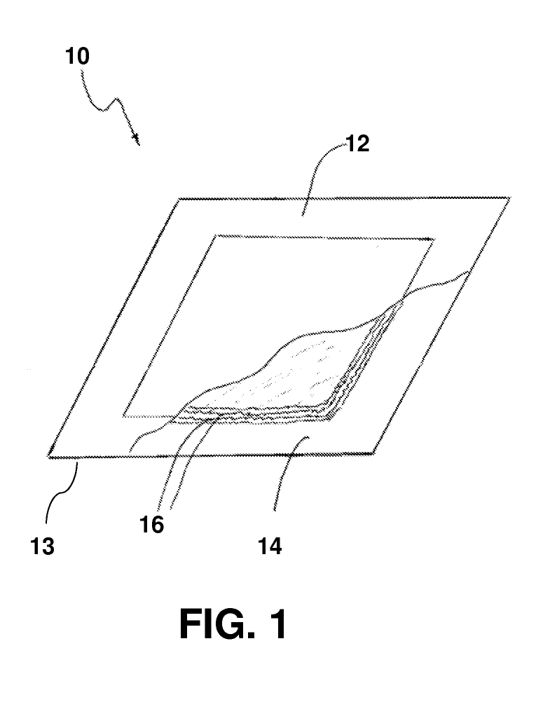

Referring to the drawings and, in particular, FIG. 1, there is shown an exemplary embodiment of an absorbent pad or food pad generally represented by reference number 10. Absorbent pad 10 has a desiccant. Absorbent pad 10 can be placed in a food package or in a food display case to reduce ambient moisture and thereby prolong the shelf life and enhance the appearance of the food product. Absorbent pad 10 can further include an antimicrobial, or atmosphere modification system that is activated by the water absorbed or adsorbed by the desiccant.

Absorbent pad 10 has a top layer 12, and a bottom layer 14 opposite top layer 12. Between top layer 12 and bottom layer 14 is an absorbent body 16 made of one or more layers of an absorbent or superabsorbent material. In a preferred embodiment, top layer 12 and bottom layer 14 directly contact each other and are sealed at edges 13 to enclose absorbent body 16 and seal absorbent pad 10. A laminate 15 can also be part of absorbent pad 10. Laminate 15 can be positioned between top layer 12 and bottom layer 14.

Top layer 12 is a film that is polypropylene, polypropylene, polyester, or any combinations thereof. In an exemplary embodiment, top layer 12 is a blown polyethylene film. The blown polyethylene film can have a thickness of about 0.65 mil. In another embodiment, top layer 12 is any nonwoven material. In yet another embodiment, top layer 12 is made of coffee filter tissue (CFT).

Bottom layer 14 is a nonwoven material. Examples of nonwovens for bottom layer 14 include, but are not limited to, polyolefin, polyester, or polyamine. Preferably, the nonwoven is polyethylene, polypropylene, or any combinations thereof. In a preferred exemplary embodiment, bottom layer 14 is made of spunbonded polypropylene.

As used in this application, “nonwoven”, “nonwoven material” and “nonwoven substrate” have the same meaning. The nonwoven material preferably has a basis weight between about 15 GSM (Grams per Square Meter) to about 35 GSM. “Basis weight” as used in this application, means the mass of a unit area of the nonwoven material, and is measured in Grams per Square Meter (GSM).

Nonwoven materials in top layer 12 and bottom layer 14 are inherently hydrophobic. Prior to treatment with a surfactant, top layer 12 and bottom layer 14 are substantially impermeable to liquid exuded from food products. Addition of a surfactant to the nonwoven increases permeability (and increases strikethrough) of top layer 12 and bottom layer 14 to liquids exuded from a food product (not shown). Generally, the greater the amount of surfactant, and the thinner the nonwoven (as measured in GSM), the faster the speed of strikethrough.

Absorbent pad 10 can include a desiccant. The desiccant is preferably positioned in or on absorbent body 16. A preferred desiccant is calcium chloride (CaCl₂). Calcium chloride in an anhydrous state is deliquescent. Anhydrous calcium chloride can effectively accumulate a large amount of water in its crystal lattice before dissolving.

Hygroscopic substances are able to attract and hold water molecules from the surrounding environment through either absorption or adsorption. Absorption is a process in which atoms, molecules, or ions enter a bulk phase, such as a gas, liquid or solid. Adsorption is a process in which atoms, molecules, or ions from a gas, solid or liquid adhere to a surface.

As water molecules are absorbed or adsorbed by a material or compound, the material's physical characteristics are altered. For example, there can be an increase in volume. Hygroscopic materials have a tendency to dampen or “cake up” when exposed to moisture in the air. The amount a particular material or compound is affected by ambient moisture can be represented by coefficients, such as a coefficient of hygroscopic expansion (“CHE”), a coefficient of moisture expansion (“CME”) or a coefficient of hygroscopic contraction (“CHC”).

Examples of hygroscopic substances include, but are not limited to, zinc chloride, calcium chloride, potassium hydroxide, and sodium hydroxide.

Deliquescence is a property of certain materials that are so hygroscopic that they readily dissolve in the water that they absorb. Deliquescent materials have a strong affinity for moisture and will absorb relatively large amounts of water from the atmosphere.

Deliquescent salts include, but are not limited to: calcium chloride; magnesium chloride; zinc chloride; potassium carbonate; potassium phosphate; carnallite; ferric ammonium citrate; potassium hydroxide; and sodium hydroxide. A high affinity for water is desirable in a desiccant.

A desiccant is a hygroscopic substance that is used to maintain a certain level of localized dryness, preferably in a sealed container.

Examples of desiccants include, but are not limited to, calcium chloride, calcium sulfate, silica gel, activated charcoal, and clay.

A humectant is a hygroscopic substance used to maintain a certain moisture level. A humectant attracts and retains moisture or water vapor from the air via an absorption mechanism. A humectant often has several hydrophilic groups and a high affinity to form hydrogen bonds with molecules of water. Examples of humectants include, but are not limited: polyethylene glycol (PEG), polypropylene glycol (PPG), salts thereof, glycerin, and glycerol. As a food additive, a humectant is used to keep food products moist.

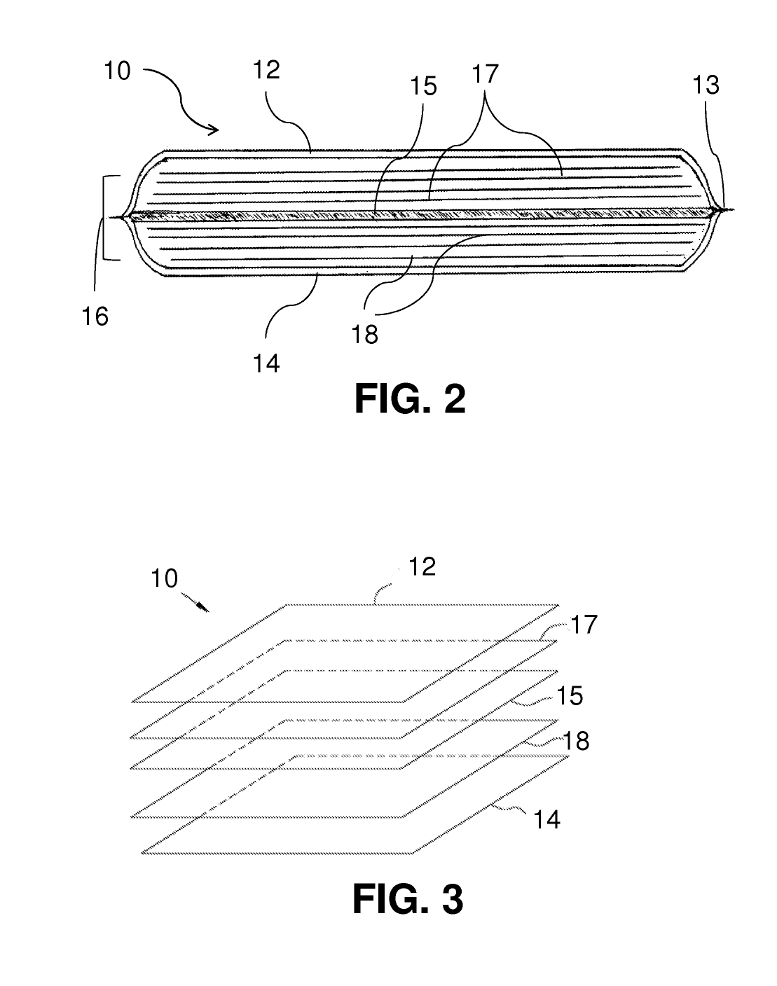

Referring to FIGS. 2 and 3, in this exemplary embodiment, absorbent pad 10 has top layer 12 and bottom layer 14 that are sealed at edge 13 to enclose a desiccant layer 15 between two tissue layers 17 and 18.

Top layer 12 can be polyethylene (“PE”) or polypropylene (“PP”).

Desiccant layer 15 can be comprised of calcium chloride powder dispersed in a laminate.

As mentioned above, desiccant layer 15 is between or sandwiched between tissue layers 17 and 18. Each tissue layer 17 and 18 can be a plurality of layers. Tissue layers 17 and 18 can wick away moisture and water via capillary mechanisms in all dimensions. Tissue layers 17 and 18 hold and retain excess moisture (water vapor) and water in the pad. The moisture or water can be absorbed by tissue layers 17 and 18 from the food product, and/or wicked away from the desiccant. Tissue layers 17 and 18 can trap and hold excess moisture and water so that the desiccant in desiccant layer 15 does not migrate from the pad to contact and potentially contaminate the food product in the food package. By wicking moisture and water away from the desiccant, a tissue layer can also decrease the extent of dissolution and/or decrease the rate at which the desiccant dissolves, thereby preserving the effective life of the desiccant and prolonging the time during which the desiccant can absorb or adsorb moisture in the food package.

A tissue layer also allows a deliquescent desiccant to be used in the pad in a food package, as the tissue layer prevents migration of the desiccant onto the food product, by wicking water and moisture away from the deliquescent desiccant, by holding and trapping water, and by slowing transport of dissolved desiccant through the absorbent layers of the pad structure.

Tissue layers 17 and 18, with top layer 12 and bottom layer 14, act in conjunction to prevent dissolution and migration of the desiccant from the pad to contact and potentially contaminate a food product in the food package. Thus, embodiments of the present disclosure with a pad structure having a desiccant and at least one tissue layer (such as those embodiments having tissue layers 17 and 18 above) and/or a laminate layer having an absorbent material, reduce the risk of contamination of the packaged food by the desiccant, and increase food safety as compared with a desiccant inside a conventional sachet that lacks an absorbent tissue layer or absorbent laminate layer.

Each tissue layer 17 and 18 is made of absorbent and/or superabsorbent material that absorbs moisture and liquids that exude from a food product placed on absorbent pad 10. Each tissue layer 17 and 18 itself can be formed of one or more cellulosic layers adjacent to each other or joined together to form the absorbent layer. Examples of absorbent material include, but are not limited to, natural tissue, fluff pulp, cellulosic material, binding fiber, airlaid, nonwoven, polymer, absorbent gel, thermoplastic polymer fiber, cellulose powder, and any combinations thereof. Examples of a superabsorbent material can include, but are not limited to, superabsorbent polymer (SAP), compressed SAP, composite of SAP granules adhered with binder or plasticizer, airlaid with SAP, and/or a starch-based superabsorbent material, such as BioSAP™ (Archer-Daniels Midland, Decatur, Ill.), which is biodegradable and compostable.

The number of tissue layers 17 and 18, as well their arrangement in the pad architecture of absorbent pad 10, can vary to regulate the absorption for the pad, as well as activation of any active agents therein. As used in this application, the “pad architecture” of a pad means the structure and order of individual layers of tissue layers 17 and 18, and any active agents therein. “Regulation” as used in this application, means controlling the speed, location, and amount of liquid or moisture absorption, as well as controlling activation speed and duration of release of active agents.

Bottom layer 14 can be a nonwoven (NW), Coffee Filter Tissue (CFT), polyethylene (PE), or polypropylene (PP).

The top and bottom surfaces or layers 12, 14, respectively, of absorbent pad 10 are inherently non-slip surfaces (i.e., having a high coefficient of friction). This is largely due to the fibers of the nonwoven used for top layer 12 and bottom layer 14. The non-slip characteristics of absorbent pad 10 can reduce or prevent slippage of a food product that is positioned on top layer 12 or bottom layer 14, whichever layer is facing upward to contact the food product. The non-slip characteristics also reduce or prevent slippage of absorbent pad 10 in a food tray. In a preferred embodiment, top layer 12 and bottom layer 14 are treated with a surfactant that does not substantially affect the non-slip properties of absorbent pad 10.

The amount of exuded liquids that can be absorbed and retained by tissue layers 17 and/or 18 depends primarily on the nature of absorbent material and the number of absorbent layers. However, absorbency is also related to the nonwovens in top layer 12 and bottom layer 14, which provide a physical barrier that also helps retention of liquids absorbed in the absorbent layers. As used in this application, “retention” and “retention capability” mean how much exuded liquid that is absorbed is retained in the absorbent material in absorbent pad 10. Thus, if absorbent pad 10 has nonwovens in top layer 12 and/or bottom layer 14 that are too thin (i.e., have a low basis weight), or have too high a percent (%) surfactant, or a combination of these, absorbent pad 10 can lose part or all of its retention capabilities.

In a preferred exemplary embodiment of absorbent pad 10, neither top layer 12 nor bottom layer 14 have any perforations in the nonwoven. In another exemplary embodiment, top layer 12 and bottom layer 14 are each mechanically perforated to the same extent, such as when the same perforated nonwoven stock material is used for top layer 12 and bottom layer 14 to manufacture absorbent pad 10.

As mentioned above, absorbent pad 10 is sealed all around at edge 13. This sealing, in combination with top layer 12 and bottom layer 14, prevent any escape of desiccant from desiccant layer 15 and thus any food contamination.

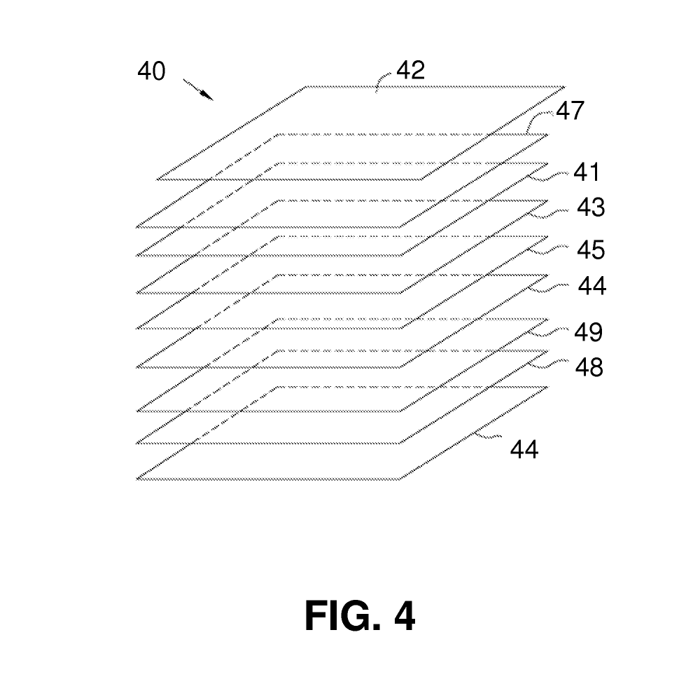

In another exemplary embodiment, absorbent pad 10, or pad 40 as in FIG. 4, can have a carbon dioxide generation system.

An example of a carbon dioxide generation system for pad 40 is a mixture of an acid and a base, such as citric acid and sodium bicarbonate, respectively. The ratio of citric acid to sodium bicarbonate is one factor (with the primary factors being the architecture of the absorbent pad and the placement and type of the active agent in the absorbent pad) that affects the amount of carbon dioxide released in a food package. In an exemplary embodiment, a ratio of about 4:6 (citric acid:sodium bicarbonate) can be employed to release sufficient carbon dioxide for food preservation. However, other ratios can be selected based on other factors, such as the pKₐ of the acid selected.

The citric acid used as an active agent in the carbon dioxide generation system provides an additional beneficial function, by interacting with the sodium ion of sodium bicarbonate to create a citric acid/sodium citrate system acting as a buffer to maintain the pH within food-compatible ranges in the food package. The citric acid-citrate buffer system is also beneficial in absorbent pads having an oxygen scavenger as an atmosphere modifier, as excessively low pH can inactivate certain oxygen scavengers.

Elevation of carbon dioxide inhibits both microbiological growth and slows some enzymatic activity. Because of dissolution of carbon dioxide gas in muscle, fat and other tissue, and permeation and transmission of the gas through package structures, concentration of this gas in equilibrium with the food is often decreased below the optimum or even effective level.

Pad 40 has a top layer 42 and a bottom layer 44 opposite top layer 42. Between top layer 42 and bottom layer 44 are tissue layers 47, 43, 44, and 48. For the embodiment shown in FIG. 4, between tissue layers 47 and 43 is an acid layer 41, and between tissue layers 44 and 48 is a base layer 49. Between tissue layers 43 and 44 is desiccant layer 45.

Desiccant layer 45 works in a similar way to desiccant layer 15.

When reacted together, sodium bicarbonate layer 49 and citric acid or boric acid layer 41 generate carbon dioxide. The desiccant, preferably calcium chloride, activates the carbon dioxide generation system. Calcium chloride is the initiator or promoter of the carbon dioxide to produce a reaction by absorbing water and water vapor from the air. The sodium bicarbonate pulls the water from the calcium chloride and, in conjunction with the citric acid or boric acid, initiates a reaction that generates carbon dioxide.

As shown in FIG. 4, the active agent can be a two-component system. Specifically, the active agent in FIG. 4 is a carbon dioxide generation system that includes a first component, acid layer 41, and a second component, base layer 49. Acid layer 41 and base layer 49 can be separated from one another by tissue layer 43, tissue layer 44 and desiccant layer 45. FIG. 4 shows desiccant layer 45 positioned between tissue layer 43 and tissue layer 44; acid layer 41 positioned between tissue layer 47 and tissue layer 43; and base layer 49 positioned between tissue layer 44 and tissue layer 48. Thus, the active agent can be in one or more layers that are separate from the layer with the desiccant.

Alternatively, it is envisioned that the active agent can be positioned with the desiccant, i.e., in desiccant layer 45 or in the laminate layer. Another alternative envisioned, is that the active agent is a one component system and is positioned in a layer or adjacent the desiccant layer 15 and, preferably in such an envisioned embodiment, the active agent is positioned adjacent the desiccant and toward the top layer 12.

While described as having a certain number of layers, absorbent pads 10 and 40 can have any number of layers between top layer 12, 42 and bottom layer 14, 44. The layers in absorbent body 16 can be in any order.

There can be multiple desiccant layers 15 and 45.

Acid layer 41 and base layer 49 can be the same layer.

While described as sodium bicarbonate and citric acid or boric acid, carbon dioxide generation can be achieved using other acid-base reactions.

Absorbent pads 10 and 40 can have an oxygen scavenger layer (not shown). An oxygen scavenging system in absorbent pads 10 and 40 can include enzyme catalyzed oxidation reaction, metal oxidation reaction, or any combinations.

Absorbent pads 10 and 40 can also have one or more antimicrobial agents, one or more atmosphere modification systems, or any combinations thereof. An antimicrobial agent can be selected from a bacterial inhibitor, fungal inhibitor, viral inhibitor, disinfectant, mildew stat, or any combinations. Examples of antimicrobial agent include, but are not limited to, a metal, metal compound, organic acid, inorganic acid, quaternary ammonium salt, sulfite, biopolymer, synthetic polymer, chitin, chitosan, nisin, enzymatic system, antioxidant, and any combinations. Examples of an atmosphere modification system can be a carbon dioxide generation system, oxygen scavenging system, ethylene blocking or scavenging system, or any combination.

Scaling, i.e., selecting the proper amounts of desiccant and/or carbon dioxide generation in relation to the amount of absorbent material and the type of food product being packaged, effects the performance of absorbent pad 10. Some food products exude very little moisture or liquid, while other foods exude a large amount of moisture or liquid that must be acquired by the absorbent layers. For example, if absorbent pad 10 has too many absorbent tissue layers relative to the amount of moisture and water, the tissue layers slow the transport of moisture and water through the pad to contact the desiccant, which can result in insufficient water being available to initiate activation of an atmosphere modification system, such as a carbon dioxide generation system and/or oxygen scavenging system. Conversely, if absorbent pad 10 has too few absorbent layers, a large volume of moisture or water can dilute or dissolve the desiccant, thereby impairing the effectiveness of the desiccant.

Pad architecture can be selected to regulate the uptake of moisture by a food product on absorbent pads 10 or 40, as well as to regulate carbon dioxide generation system activation, rate of release, and duration. A pad architecture that physically separates the individual chemical components can delay activation and/or provide an “extended release” of the active agent.

While described and illustrated as a generally rectangular pad, absorbent pads 10 and 40 can take on many different shapes. Different shapes can indicate different food products, such as, for example, baguettes, flat breads, muffins, and similar.

Absorbent pads 10 and 40 can also serve as a spacer or barrier between the food product and its container, which container can be a bag.

Absorbent pads 10 and 40 disclosed herein can be used in food packages to extend shelf life and food freshness. Absorbent pads 10 and 40 can enhance the appearance of packaged foods.

Absorbent pads 10 and 40 can be a component of a case-ready food package. The case-ready food package includes a food tray and pad positioned on the food tray with a food product positioned thereon. The package is sealed so that the internal environment remains enclosed and the package is resistant to transport phenomena.

Manipulation of hygroscopic properties can be useful in any application that has the possibility of condensation inside the package, such as baking applications. Moisture content can be affected to produce varying levels of crispiness. Different quantities and varieties of sugar can produce crunchy, crispy, or chewy effects.

The present disclosure further includes a method of using an absorbent pad having a desiccant and optionally another active agent or system to prolong the shelf life and enhance the appearance of a food product, particularly any food product that fosters condensation in the package after packaging, such as baked foods and pre-baked frozen food products.

In an exemplary embodiment, the pad having a desiccant of the present disclosure can be positioned in a food package along with a pre-baked food that has been partially or completely baked and then frozen for transporting and shipping to a retail grocery store or to a restaurant. Condensation that forms in the food package during storage and transport is absorbed by the desiccant (or adsorbed, depending on the type of desiccant selected), and also absorbed by one or more tissue layer and/or absorbent laminate layer in the pad structure. Water that is absorbed or adsorbed by the desiccant and by the tissue layers or laminate layer can activate another active system in the absorbent pad (if present), for example, an atmosphere modification system (including, but not limited to, carbon dioxide generation system, oxygen scavenging system, or ethylene scavenging system) or an antimicrobial agent.

Thawing the pre-baked frozen food product during storage and transport increases the amount of water and moisture inside the food package, which is then absorbed by the desiccant and absorbent tissue layers or laminate layer, to prolong the shelf life and enhance the appearance and freshness of the baked food. In other embodiments, the pre-baked frozen food product is deliberately thawed when reaching a retail grocery store or restaurant, so that the consumer purchases the pre-baked food partially or completely thawed. In these embodiments, deliberately thawing the pre-baked frozen food product during storage and transport also increases the amount of water and moisture inside the food package, which is absorbed by the desiccant and absorbent tissue layers or laminate layer, to prolong the shelf life and enhance the appearance and freshness of the baked food. In each of the embodiments, the absorbing of excess moisture and water generated by thawing by the desiccant and by the tissue layers and/or absorbent laminate layer inhibits the growth of mold in the package or on the food product to extend shelf life and consumer appeal of the food product.

The pad structure, having a top layer, a bottom layer, one or more tissue layers positioned between the top layer and bottom layer, and having a desiccant in the pad (for example, positioned between two adjacent tissue layers or positioned in a separate layer that is adjacent to a tissue layer, prevents the desiccant from dissolving and escaping outside of the pad, where the dissolved desiccant could potentially contaminate the food product.

In each embodiment of the method, positioning a pad having a desiccant of the present disclosure in a food package with a food product enhances shelf life, appearance and freshness of the food product, and reduces the risk of food contamination by microorganisms (e.g., mold), or by the dissolved desiccant. The optional addition of another active system in the pad, such as an atmosphere modification system (including, but not limited to, carbon dioxide generation system, oxygen scavenging system, or ethylene scavenging system) or an antimicrobial agent, can be activated by water wicked away from the desiccant and absorbent tissue layers (or absorbent laminate layer) in the pad to further enhance shelf life, appearance and freshness of the food product, and reduce the risk of food contamination by microorganisms, such as bacteria or mold.

As used in this application, the word “about” for dimensions, weights, and other measures means a range that is ±10% of the stated value, more preferably ±5% of the stated value, and most preferably ±1% of the stated value, including all subranges therebetween.

As used herein, all references to the plural can also mean the singular and to the singular can also mean the plural, unless otherwise indicated.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications, and variances that fall within the scope of the disclosure.

What is claimed is:

1. An absorbent food pad for use in a food package or food display case having food therein comprising:
a top layer;
a bottom layer;
an absorbent body positioned between the top layer and the bottom layer; and
a desiccant positioned in or on the absorbent body,
wherein the desiccant absorbs or adsorbs ambient moisture in the food package or food display case to prolong the shelf life and enhance the appearance of the food.

2. The absorbent food pad according to claim 1, wherein the absorbent body further comprises:
a first tissue layer positioned adjacent the top layer; and
a second tissue layer positioned adjacent the bottom layer.

3. The absorbent food pad according to claim 2, wherein the first tissue layer and the second tissue layer trap excess moisture and water absorbed from the food product, and wick away moisture from the desiccant.

4. The absorbent food pad according to claim 2, wherein the desiccant is positioned between the first tissue layer and the second tissue layer.

5. The absorbent food pad according to claim 2, wherein the absorbent body also includes a desiccant layer positioned between the first tissue layer and the second tissue layer, wherein the desiccant layer is a separate layer from the first tissue layer and the second tissue layer, and wherein the desiccant is in the desiccant layer.

6. The absorbent food pad according to claim 1, wherein the top layer is sealed to the bottom layer to enclose the desiccant therein.

7. The absorbent food pad according to claim 1, wherein the absorbent body further includes a laminate layer.

8. The absorbent food pad according to claim 7, wherein the desiccant is dispersed in the laminate layer.

9. The absorbent food pad according to claim 1, wherein the desiccant is selected from the group consisting of calcium chloride, calcium sulfate, silica gel, activated charcoal, clay, and any combinations thereof.

10. An absorbent food pad for use in a food package or food display case having food therein comprising:
a top layer;
a first tissue layer positioned adjacent the top layer;
a second tissue layer positioned adjacent the first tissue layer opposite the top layer;
a third tissue layer positioned adjacent the second tissue layer opposite the first tissue layer;
a fourth tissue layer positioned adjacent the third tissue layer and opposite the second tissue layer;
a bottom layer adjacent the fourth tissue layer and opposite the third tissue layer,
wherein the first tissue layer, the second tissue layer, the third tissue layer, and the fourth tissue layer define an absorbent body of the absorbent food pad; and
a desiccant positioned in or on the absorbent body, wherein the desiccant absorbs or adsorbs ambient moisture in the food package or food display case to prolong the shelf life and enhance the appearance of the food.

11. The absorbent food pad according to claim 10, wherein the absorbent body traps excess moisture and water absorbed from the food product, and wick away moisture from the desiccant, to prevent migration of the desiccant from the absorbent food pad toward the food product.

12. The absorbent food pad according to claim 10, wherein the absorbent body also includes a desiccant layer positioned between the second tissue layer and the third tissue layer, wherein the desiccant layer is a separate layer from the second tissue layer and the third tissue layer, and wherein the desiccant is in the desiccant layer.

13. The absorbent food pad according to claim 10, wherein the absorbent body further includes a laminate layer positioned between the second tissue layer and the third tissue layer, and wherein the desiccant is dispersed in the laminate.

14. The absorbent food pad according to claim 1, further comprising an active agent, wherein the active agent is positioned with the desiccant.

15. The absorbent food pad according to claim 14, wherein the active agent is selected from the group consisting of an antimicrobial agent, atmosphere modification system, and any combinations thereof.

16. The absorbent food pad according to claim 14, wherein the active agent is activated by liquid absorbed or adsorbed by the desiccant.

17. The absorbent food pad according to claim 14, wherein the active agent is an agent selected from the group consisting of a carbon dioxide generation system, an oxygen scavenging system, ethylene blocking system, ethylene scavenging system, and any combinations thereof.

18. The absorbent food pad according to claim 10, wherein the food is a product selected from the group consisting of breads, flat breads, pita breads, baguettes, croissants, pastries, cookies, muffins, cakes, and any combinations thereof.

19. A method for prolonging the life and appearance of a food product in a food package, comprising:
positioning an absorbent food pad in the food package, the absorbent food pad comprising:
a top layer;
a bottom layer;
an absorbent body positioned between the top layer and the bottom layer; and
a desiccant positioned in or on the absorbent body, wherein the desiccant absorbs or adsorbs ambient moisture in the food package;
placing the food product on the absorbent food pad; and
closing the food package to enclose the food product and absorbent food pad therein.

20. The method according to claim 19, further comprising thawing the food product during transport or storage of the food product to increase the amount of water and moisture inside the food package.
